(19) United States
(12) Patent Application Publication
(10) Pub. No.: US 2023/0214650 A1
(43) Pub. Date: Jul. 6, 2023

(54) METHOD AND SYSTEM FOR META-LEARNING OF NEURAL COMBINATORIAL OPTIMIZATION HEURISTICS

(71) Applicant: NAVER CORPORATION, Seongnam-si, Gyeonggi-do (KR)

(72) Inventors: Jean-Marc ANDREOLI, Meylan (FR); Sofia MICHEL, Grenoble (FR); Sahil MANCHANDA, Delhi (IN)

(21) Appl. No.: 18/055,613

(22) Filed: Nov. 15, 2022

Related U.S. Application Data
(60) Provisional application No. 63/266,382, filed on Jan. 4, 2022.

(51) Int. Cl. G06N 3/08

(52) U.S. Cl. CPC G06N 3/08

(57) ABSTRACT

Methods and systems for training a neural combinatorial optimization (NCO) model having a processor and memory for performing a task having a target distribution. The NCO model is meta-trained to learn an efficient heuristic on a set of distributions. The meta-trained NCO model is then fine-tuned to specialize a learned heuristic for the target distribution.

### PRIORITY INFORMATION

This application claims priority to and benefit from U.S. Provisional Patent Application Ser. No. 63/266,382, filed Jan. 4, 2022, which application is incorporated in its entirety by reference herein.

### FIELD

The present disclosure relates generally to machine learning, and more particularly to methods and systems for training neural combinatorial optimization models.

### BACKGROUND

Combinatorial optimization (CO) is used to find optimal decisions within finite sets of possible decisions where the sets are typically so large that exhaustive search is not possible. CO problems appear in various types of applications in fields such as but not limited to logistics, transportation, finance, energy, manufacturing, and others.

Because CO problems can be very complex (e.g., generally NP-hard), exact algorithms are typically prohibitively expensive for solving large-scale problem instances. Heuristics are often used to assist in finding suitable solutions. Heuristics are efficient algorithms that compute generally acceptable or good solutions, but without approximation certificates. Heuristics are useful to CO not only for applications in which optimality guarantees are not required, but also for exact solvers, which generally exploit numerous heuristics in order to guide and accelerate their search procedure.

However, designing heuristics typically heavily relies on problem-specific knowledge, or at least a designer's experience of similar problems, to adapt generic methods to the setting at hand. This design skill, which human experts can acquire with experience, but which is difficult to capture formally, can be assisted using statistical methods.

To this end, machine learning methods using Neural Combinatorial Optimization (NCO) have been successfully applied to solve CO problems. NCO has shown remarkable results by leveraging deep neural networks to model and automatically derive efficient CO heuristics.

CO problems are highly structured and often formulated on graphs. As a result, advances in sequence-to-sequence (seq2seq) models and graph neural networks have been employed to improve NCO methods.

However, current NCO heuristics suffer from poor generalization. For instance, NCO models are often trained on graphs of a fixed size and perform well on unseen graphs of the same size, but when tested on larger ones, performance degrades drastically.

Approaches have been disclosed to attempt to address this size variation. For example, to address poor generalization with respect to graph size of NCO heuristics such as for the Traveling Salesman Problem (TSP), approaches such as those disclosed in Joshi et al., Learning TSP Requires Rethinking Generalization, arXiv:2006.07054 [cs, stat], June 2020, provide a unified experimental framework to investigate zero-shot generalization of existing NCO models for learning large-scale TSP. Such methods employ certain architecture choices (e.g., graph neural network (GNN) aggregation functions and normalization schemes) and inductive biases (auto versus non-auto regressive models) for out-of-distribution generalization.

Lisicki et al., Evaluating Curriculum Learning Strategies in Neural Combinatorial Optimization. arXiv:2011.06188 [cs], November 2020, discloses a curriculum learning approach using an adaptive staircase strategy to train an attention model disclosed in Kool et al., Attention, Learn to Solve Routing Problems! September 2018, https://openreview.net/forum?id=ByxBFsRqYm2018, in a multi-task setting. In the approach disclosed in Lisicki et al., each task corresponds to graphs of a fixed size, with node coordinates uniformly sampled from the unit square. It was assumed that exact (or very good) solutions could be accessed during training, and an optimality gap was used to guide the scheduling of the tasks. This example approach can be viewed as a semi-supervised one.

Although this approach improves the original model's generalization, it is still quite limited. For instance, on graphs of size 80, the disclosed model performed similarly to an attention model trained on size 50, while on size 100, it performed just below the original model trained on size 100.

Another size-specific approach disclosed in Fu et al. 2020, Generalize a Small Pre-trained Model to Arbitrarily Large TSP Instances, arXiv:2012.10658 [cs], December 2020, starts by training a model (a graph convolutional residual neural network with attention mechanisms) on graphs of a small, fixed size. The model learns, in a supervised way, to output a probability for each edge of being part of the optimal solution, Then, for a larger TSP instance, the model is applied on sampled subgraphs of the fixed small size, and the heatmaps of the different subgraphs are averaged and used to guide a Monte Carlo Tree Search procedure. The results improved on those disclosed in Kool et al. and Joshi et al., managing to solve instances with up to 10,000 nodes.

Although size variation is a common case of poor generalization, the present inventors have recognized that such approaches lack generalization to out-of-distribution instances of the CO problems. Instances of the same size may still vary enough to cause generalization issues. This limitation can hinder the application of NCO methods in various applications in which the relevant distributions are often not known in advance and can vary with time.

### SUMMARY

Provided herein, among other things, are methods and systems for training a neural combinatorial optimization (NCO) model using a processor and memory for performing a task having a target distribution. The NCO model is meta-trained to learn an efficient heuristic on a set of distributions. The meta-trained NCO model is then fine-tuned to specialize a learned heuristic for the target distribution.

According to a complementary aspect, the present disclosure provides a computer program product, comprising code instructions to execute a method according to the previously described aspects; and a computer-readable medium, on which is stored a computer program product comprising code instructions for executing a method according to embodiments and aspects provided herein. The present disclosure further provides a processor configured using code instructions for executing a method according to embodiments and aspects provided herein.

Other features and advantages of the invention will be apparent from the following specification taken in conjunction with the following drawings.

### DESCRIPTION OF THE DRAWINGS

The accompanying drawings are incorporated into the specification for the purpose of explaining the principles of the embodiments. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIGS. 1-2 show example samples from various NCO tasks with graph distributions by three parameters: the number of nodes (graph size N), the number of modes (M), and the scale (L), where the smaller dots (e.g., dots 102, 202) represent graph nodes in samples from T_{N=300,M=3,L=1}(FIG. 1) and T_{N=300,M=7,L=1}(FIG. 2), and the larger dots (e.g., dots 104, 204) are generated modes around which the nodes tend to cluster.

FIG. 3 shows an example method for training an NCO graph-based model.

FIG. 4 shows an example meta-training method for an NCO graph-based model.

FIG. 5 shows an example method for training the learned NCO heuristic given a target distribution.

FIG. 6 shows an example method for meta-training an attention model-based heuristic.

FIG. 7 shows steps in an example meta-training method for an example supervised model.

FIG. 8 shows an example method for performing an NCO task using a fine-tuned specialized model.

FIG. 9 shows an example architecture that may be used for performing example methods.

FIGS. 10A-10L show an evolution of performance (optimality gap, vertical axis) of various models (meta-AM finetuned-N 1002, multi-AM finetuned-N 1004, original attention model AM-N 1006, and Farthest insertion 1008) on different tasks, where the distributions in each group of four (FIGS. 10A-10D; FIGS. 10E-10H, FIGS. 10I-10L) belong to a subfamily of T_{N,M,L} where two of the parameters among varying graph size N, number of modes M, and scale L are fixed and only the third is allowed to vary: N (FIGS. 10A-10D); M (FIGS. 10E-10H); and L (FIGS. 10I-10L).

FIGS. 11A-11L show a comparison of performance across various models: (1) an AM (attention model) meta-trained on a set of distributions of the same subfamily as the distributions in the same group but distinct from them (meta-AM, indicating meta-AM training 1102 and meta-AM finetuned-N 1104); (2) the AM model trained from scratch on the same distribution as in test (AM training-N 1106); and (3) a Farthest Insertion model 1108, where the parameters N, M, L are varied.

FIGS. 12A-120 show training performance of meta-AM with task weights (left portion 1202 of each combined bar) and without task weights (right portion 1204 of each combined bar) for a set of tasks with varying graph size N (A), number of modes M (B), and scale L (C).

FIGS. 13A-130 show test performance, measured by the true optimality ratio, of the example meta-AM model with task weights (left portion 1302 of each combined bar) or without task weights (right portion 1304 of each combined bar) on the set of tasks with varying graph size N (A), number of modes M (B), and scale L (C).

FIG. 14 shows the evolution of the performance with example fine-tuning steps (meta-GCN finetuned-100) 1402 compared to a GCN model trained from scratch (GCN training-100) 1404, for 24 hrs. on an experimental test distribution.

In the drawings, reference numbers may be reused to identify similar and/or identical elements.

### DETAILED DESCRIPTION

Meta-learning methods and systems according to embodiments herein are provided for learning robust neural combinatorial optimization (NCO) heuristics. Methods that exploit the principle that one-size-fits-all models for combinatorial optimization (CO) can be unsuitable because the space of graphs and graph distributions for practical applications is incommensurable. This problem is addressed in example methods by viewing a CO problem over a given distribution of graphs as a separate task.

Meta-learning, e.g., as disclosed in J. Schmidhuber, Evolutionary principles in self-referential learning, or on learning how to learn: the meta-meta-hook, Diploma thesis, Inst. f. Inf., Tech. Univ. Munich, 1987. http://www.idsia.chrjuergen/diploma.html, is a useful approach to obtain a model that can adapt to new, unseen tasks. In meta-learning generally, a model is trained on a variety of tasks by optimizing the model's aggregated ability to adapt to each of them. Then, at test time, when presented with a new task, the model can be fine-tuned using a small amount of data from that new task.

Example methods are generally applicable to both supervised and reinforcement learning of graph-based NCO models. Such example methods can account for any kind of distribution shift, including but not restricted to graph size. For example, some example meta-learning methods can adapt NCO training approaches based on reinforcement learning, such as those disclosed in Kool et al., Attention, Learn to Solve Routing Problems! September 2018. URL https://openreview.net/forum?id=ByxBFsRqYm.2018, which uses a self-attention encoder-decoder architecture, trained using the REINFORCE algorithm.

Other example meta-learning methods can adapt NCO approaches based on supervised learning. An example supervised learning approach that may be used is disclosed in Joshi et al., An Efficient Graph Convolutional Network Technique for the Travelling Salesman Problem. arXiv:1906.01227 [cs, stat], June 2019, which combines Graph Convolutional Network embeddings with beam search.

Methods herein generally apply a model-agnostic meta-learning (MAML) procedure to reinforcement learning-based and/or supervised learning-based NCO approaches. In example meta-learning methods, an NCO model's parameters are trained to fine-tune efficiently on unseen tasks by optimizing their fine-tuning behavior on the training tasks. In this way, even where the final distribution of graphs is unknown, by learning to adapt to different distributions during training, an example trained meta-learning model (a meta-trained model) can efficiently adapt to unseen tasks at test time.

A task weighting scheme can be provided to balance the learning between all tasks. This can be useful, for instance, to account for the variety of possible graph distributions and their corresponding loss values. Example task weighting schemes can be general yet easily implementable.

Experimental results herein demonstrate that example meta-learning methods can alleviate generalization issues present in prior NCO adaptation approaches. For instance, after a short period (e.g., on the order of minutes, though this can be smaller or greater) of example fine-tuning and using a limited number of graphs from a new, unseen distribution, example meta-trained NCO models were able to catch up to, and frequently outperform, original NCO models that were trained from scratch on the new graph distribution.

NCO models trained according to meta-learning methods herein can solve various graph-based NCO problems that are employed in many applications. One nonlimiting type of graph-based NCO problem that may be solved by example meta-trained NCO models is the well-known Traveling Salesman Problem (TSP), which involves finding a cycle of minimal length that visits each node of a graph exactly once. Other example graph-based NCO problem types include but are not limited to vehicle routing problems. Graph-based CO problems that can be solved using example meta-trained NCO models have application in logistics and transportation, among other applications.

Problem Formalization

A formalization of a general NCO out-of-distribution generalization problem and approach will now be discussed. While it will be appreciated that example meta-learning methods can be applied to various NCO approaches, for illustration an example method will be discussed with respect to the Euclidean Traveling Salesman Problem (TSP), which is a commonly used CO problem for applications such as logistics, transportation, and planning. For example, in transportation and logistics, the nodes may represent physical locations that a vehicle needs to visit exactly once before going back to its initial position. In a planning application, the nodes may represent tasks to be executed and edge lengths between two tasks may represent the time it takes to execute one task after the other. In that case the TSP tour is the planning of minimal duration. In these applications, the number of modes characterizes the distribution of the nodes (uniformly distributed, clustered in one group, or M groups). In this setting, the graph defining a problem instance is entirely determined by its set of nodes, that is, a point set sampled in a Euclidean space (typically the plane). The edges are implicit: there is an edge between any pair of nodes and its weight is their Euclidean distance.

To explore the effect of variability in the datasets of graphs, consider a specific family of tasks T_{N,M,L}, which defines a graph distribution by three parameters: the number of nodes (graph size N), the number of modes (M), and the scale (L). Given these parameters, a point set is generated by the following process, when M≠0: first, M points, referred to as modes, are independently sampled by an ad-hoc process, which tends to spread them evenly in the unit square; then, N points are independently sampled from a balanced mixture of M Gaussian components centered at the M modes, sharing the same diagonal covariance matrix, meant to keep the generated points within relatively small clusters around the modes; and finally, the point set is rescaled by application of a homothety of ratio L. When M=0, the N points are instead sampled uniformly in the unit square and then rescaled by L, which amounts to sampling them uniformly in the square of side L. It will be appreciated that other parameters may be used for approaches applied to other combinatorial problems.

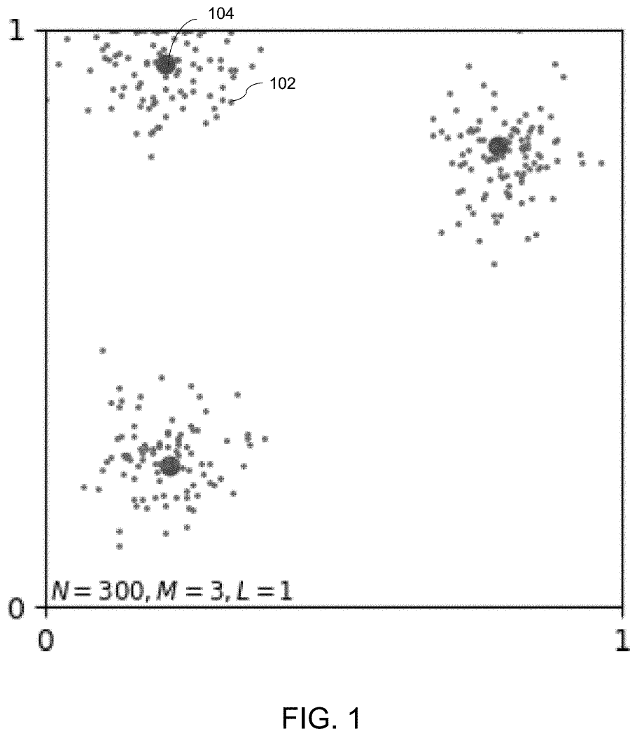

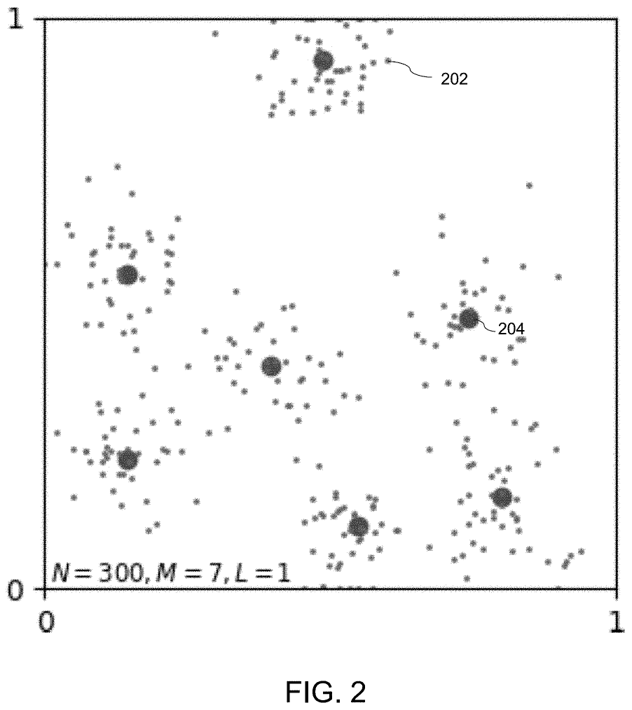

FIGS. 1-2 show example sample nodes from various tasks, where the smaller dots (e.g., dots 102, 202) represent samples from T_{N=300,M=3,L=1} (FIG. 1) and T_{N=300,M=7,L=1} (FIG. 2). The larger dots (e.g., dots 104, 204) in FIGS. 1-2 represent the generated modes, around which the nodes tend to cluster.

The performance deterioration on the generalization of a model can be measured by training the model on a given task and testing it first on the same task, then testing it on one or more other tasks, e.g., by varying one or more of the parameters N,M,L, and then comparing the performance. Naturally, the best performance results are obtained when the training task is identical to the test task. It has been found that varying the number of each of nodes, modes, or the scale can significantly degrade performance. A similar detrimental effect was found for both supervised learning NCO models and reinforcement learning NCO models.

Methods herein address such performance deterioration by providing training approaches for NCO models that are capable of out-of-distribution generalization for a given CO problem. Since NCO methods tend to perform well on fixed graph distributions, example meta-learning methods promote out-of-distribution generalization by modifying the way the model is trained while maintaining its architecture.

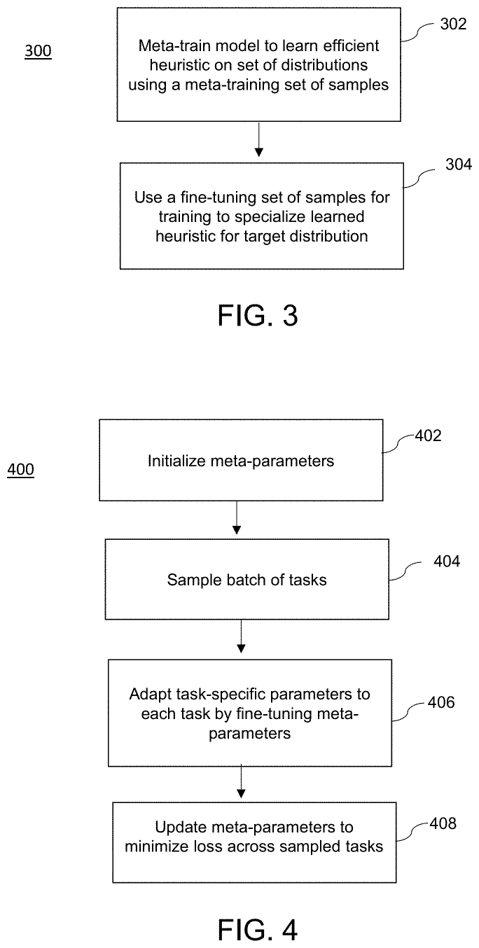

FIG. 3 shows an example method 300 for training an NCO graph-based model. The method can be implemented by a processor. Given a CO problem on graphs, such as but not limited to the TSP, one may have a prior over the relevant graph distributions, for instance an idea of one or more types of graph distributions of interest, which can be used for training. Prior knowledge or information may be provided by or based on historical data as illustrative examples. For instance, it may be known that the customers for the TSP are generally clustered around city centers, but it is not known how many clusters. A training set can be defined in part based on this prior information.

The example training method 300 first meta-trains an NCO model at 302 to learn an efficient heuristic on the prior set of distributions using a set of samples, e.g., a meta-training set of samples. Here, “efficient heuristic” refers to a model that is capable of determining a generally acceptable solution (e.g., a combinatorial optimization (CO) solution) more quickly or with less processing than using an exact algorithm. In the example situation above, this prior set of distributions may be a set of graph distributions with different numbers of clusters. The meta-training set of samples can include, for instance, sampled instances from each of a set of sampled distributions taken from the (e.g., prior selected) set of distributions. For example, the sampled distributions can include a batch of sampled tasks corresponding to different distributions from the set of distributions, and the sampled instances can include a batch of sampled graphs for each of the sampled distributions (tasks).

Then, considering a target distribution of the CO problem, a limited number of fine-tuning samples, e.g., a number of samples significantly smaller (as a nonlimiting example, a 1:1000 ratio (e.g., one thousand versus one million) of fine-tuning samples to meta-training samples or greater, though smaller ratios are also possible) than the number of meta-training samples used to meta-train the NCO model in step 302, can be used for fine-tuning to adapt or specialize the learned heuristic at 304 and maximize its performance on this target distribution. The fine-tuning set of samples can include, for instance, a set of sampled instances from the target distribution. For example, the fine-tuning set of samples can include a batch of sampled graphs for the target distribution (task).

Formally, given an NCO model and a distribution of tasks T, a goal of an example meta-training method is to compute a parameter (meta-parameter) θ such that, given an unseen task t˜T with associated loss [symbol] ₜ, after K gradient updates, a fine-tuned parameter minimizes [symbol] ₜ, that is,

$${min}_{θ} {𝔼}_{t ∼ T} [ {ℒ}_{t} ( {θ}_{t}^{( K )} ) ] , \qquad ( 1 )$$

Where θₜ^{(K)} is the fine-tuned parameter after K gradient updates of θ using batches of samples from task t. The above problem (1) can be viewed as a meta-learning optimization problem, and includes K-shot learning.

The above meta-learning problem can be approached in a model-agnostic fashion by considering certain features of a model-agnostic meta-learning (MAML) framework, e.g., as disclosed in Finn et al., Model-agnostic meta-learning for fast adaptation of deep networks. In Proceedings of the 34th International Conference on Machine Learning—Volume 70, ICML'17, pp. 1126-1135, Sydney, NSW, Australia, August 2017, and in Finn et al., Deep Representations and Gradient Descent can Approximate any Learning Algorithm. arXiv:1710.11622 [cs], February 2018. In an MAML framework, the parameters of an arbitrary model are trained to fine-tune efficiently on unseen tasks, based on the optimization of their fine-tuning behavior on the training tasks.

FIG. 4 shows an example meta-training method 400 according to step 302. In the meta-training method 400, meta-parameters are initialized at step 402, and a batch of tasks are sampled from a set of tasks at step 404. For each task in the batch, task-specific parameters are adapted to the task at step 406 by fine-tuning the current meta-parameters. The meta-parameters are then updated in order to minimize a loss that aggregates the performance of the fine-tuned parameters across all of the sampled tasks in the batch at 408.

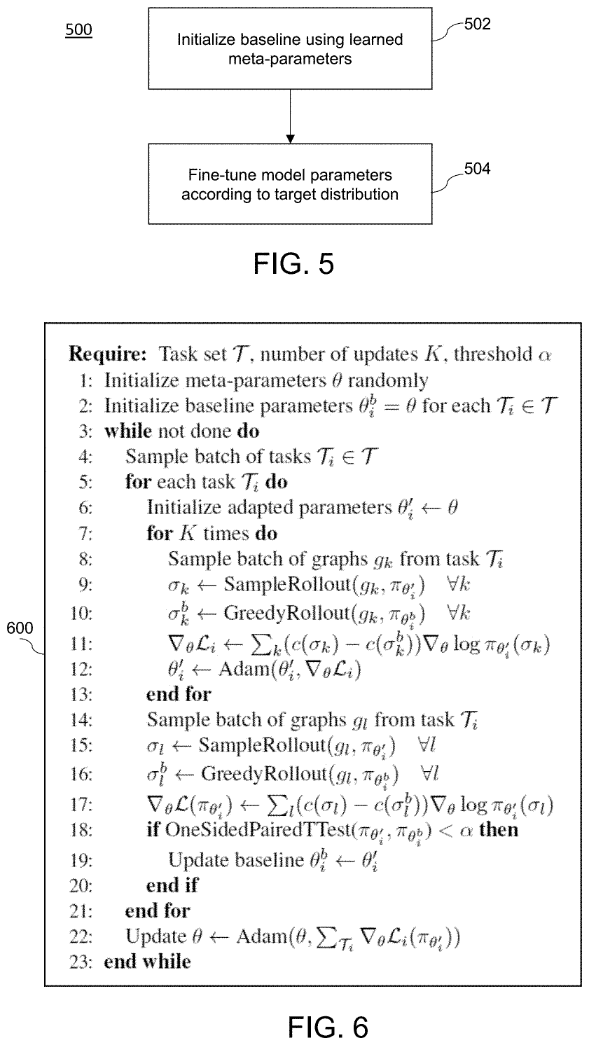

FIG. 5 shows an example method 500 for fine-tuning the learned model (heuristic) given a target distribution according to step 304. In the training method 500, a baseline is initialized at step 502 using the learned meta-parameters. The model parameters are then fine-tuned to a task at 504 according to the target distribution.

To illustrate example inventive features, example meta-learning methods of NCO models for the example TSP will now be described with respect to reinforcement learning and supervised learning approaches for NCO heuristic learning. In the following examples, the reinforcement learning model is embodied in an attention model (AM), and an example supervised learning model is embodied in a Graph Convolutional Network (GCN) based model. However, it will be appreciated that other reinforcement learning-based and supervised learning-based NCO models may be meta-trained using example methods, nonlimiting examples of which are disclosed in E. Khalil, H. Dai, Y. Zhang, B. Dilkina, and L. Song. Learning combinatorial optimization algorithms over graphs. In Advances in Neural Information Processing Systems, pages 6348-6358, 2017 (reinforcement learning); and Oriol Vinyals, Meire Fortunato, and Navdeep Jaitly. Pointer networks. In Advances in Neural Information Processing Systems, pp. 2692-2700, 2015 (supervised learning), which are incorporated herein by reference.

Meta-Learning of Reinforced NCO Heuristics

Attention Model for Heuristic Learning: An example meta-learning method will be described with respect to the reinforcement learning approach disclosed in Kool et al., 2018. This approach includes learning an NCO policy that takes as input a graph representing the TSP instance and outputs the solution as a sequence of graph nodes. The policy is parameterized by a neural network with an attention-based encoder and decoder, nonlimiting examples of which being based on a transformer-based model such as that disclosed in Vaswani et al., Attention Is All You Need. arXiv:1706.03762 [cs], June 2017.

The encoder computes nodes and graph embeddings. Using these embeddings and a context vector, the decoder produces the sequence of input nodes, one at a time. In effect, given a graph instance G with N nodes, the model produces a probability distribution π_{θ}(σ|G) from which one can sample to get a full solution in the form of a permutation σ=(σ₁, . . . σ_{N}) of {1, . . . N}. The policy parameter θ is optimized to minimize the loss:

[symbol]

(θ|G)= [symbol] _{π}_{_{θ}}_{(σ|G)}[c(σ)], (2)

Where c is the cost (or length) of the tour σ. In an example method the REINFORCE gradient estimator, e.g., as disclosed in Williams, Simple statistical gradient-following algorithms for connectionist reinforcement learning. Machine learning, 8(3-4):229-256, 1992, is used:

∇_{θ} [symbol] (θ|G)= [symbol] _{π}_{_{θ}}_{(σ|G)}[(c(σ)−b(G))∇_{θ}log π_{θ}(σ|G)]. (3)

The cost of a greedy rollout of the best model policy can be used as a baseline b, which is updated periodically during training. The update of the baseline model is based on a paired t-test over a number of separate evaluation instances.

FIG. 6 shows an example method 600 for meta-training an attention model-based heuristic such as that disclosed in Kool et al., 2018, for the TSP problem. It will be appreciated however, that the method 600 can be generalized to other graph-based NCO models that may be trained using, e.g., the REINFORCE algorithm or adapted to other reinforcement learning algorithms.

For clarity of explanation, the distribution of tasks that is considered in the illustrative example is assumed to be uniform over a finite fixed set of tasks. However, the method can be modified to handle a distribution with an infinite support simply by defining task-specific baseline parameters θᵢ^{BL} on the fly when a task is sampled for the first time.

In the example method 600, given a task set T, a number of updates K, and a stability threshold α, meta-parameters θ are initialized, e.g., randomly (line 1), and baseline parameters θᵢ^{b}=θ are initialized for each task Tᵢ∈T from the meta-parameters (line 2). A batch of tasks Tᵢ∈T are sampled from the task set (line 4).

The meta-parameters are then adapted to each of the sampled tasks Tᵢ using a fine-tuning method. In an example fine-tuning method, for each sampled task Tᵢ (line 5), task-specific adapted parameters θ′ᵢ←θ are initialized from the meta-parameters (line 6), and then are updated to minimize a loss based on the cost or length of the tours produced from a policy parameterized by the task-specific adapted parameters.

To update the task-specific adapted parameters, for each of K updates, a batch of graphs gₖ are sampled from the task Tᵢ (line 8), and the task-specific adapted parameters θ′ᵢ are updated using the sampled batch of graphs. For instance, a sample permutation σₖ (e.g., a sequence of graph nodes or a tour) (line 9) is produced by the policy to be learned (SampleRollout) by sampling according to a probability distribution for the graphs gₖ that is generated by a neural network model (e.g., with attention-based encoder and decoder) having the task-specific adapted parameters θ′ᵢ. A baseline permutation (e.g., sequence of graph nodes or tour) σₖ^{b} (line 10) is further provided by the (current) best model policy for that task (GreedyRollout) by greedily selecting the nodes of highest probability according to a probability distribution for the graphs gₖ that is produced by a task-specific baseline policy, having the most recently updated task-specific baseline parameters θᵢ^{b}.

The task-specific adapted parameters are then updated by minimizing (line 12) a loss L in the cost c, or tour length, for the tours, e.g., using the gradient estimator (line 11). In the example method, an Adam optimizer is used, though other optimizers are possible.

This fine-tuning update can be repeated, e.g., K times. Here, K can be, for instance, close to the number of fine-tuning steps that are allowed at test time (e.g., the K in K-shot learning).

The meta-parameters θ are updated (line 22) to minimize the loss that takes into account the target performance, i.e., the quality of the adapted policy, over another sampled batch of graphs gᵢ (line 14) from the same task Tᵢ. This loss is summed across all the sampled tasks Tᵢ in the batch, and optimized based on a calculated gradient (a meta-gradient). An Adam optimizer may be used for this update, though this optimizer is merely an example, and other optimizers are possible.

The baseline θᵢ^{b} need not be updated at each step, but only periodically, to improve the stability of the gradients. For instance, a sample permutation σₗ (line 15) is produced by the policy to be learned (SampleRollout) by sampling a permutation (or tour) according to the probability distribution for the graphs gᵢ that is generated by the neural network model having the updated task-specific adapted parameters σᵢ^{b}. A baseline permutation σₗ^{b} (line 16) is provided by the (current) best model policy for that task (GreedyRollout) by computing the most probable tour according to the probability distribution for the graphs gₗ that is produced by the task-specific baseline policy having the most recently updated task-specific baseline parameters θᵢ^{b}. A loss gradient for loss L in the cost c for the tours σₗ, σₗ^{b} is optimized using the gradient estimator (line 17), and a comparison of the results for the updated task-specific adapted parameters and the baseline parameters is performed, e.g., using a one-sided paired t-test (line 18). The baseline parameters for the task are updated (line 19) using the adapted task-specific parameters if the comparison result indicates a significant improvement based on the threshold α (line 18).

Once the model is meta-trained, then given a new task, the baseline is initialized at the learned meta-parameters. Fine-tuning steps, similar to lines 7-13, are performed to provide the specialized model for the new task.

The task-specific losses (Lₜ in Equation (1)) can be arbitrary. For instance, such losses may differ significantly, even in order of magnitude. To illustrate, if one considers two tasks T_{N,M,L=1} and T_{N,M,L=10}, i.e., TSPs on graph distributions with scales 1 and 10 respectively, the associated losses in Equations (1) and (2) as well as the gradients in Equation (3) may have roughly an order of magnitude of difference. Then, when summing the gradients over the tasks (line 22 of the example algorithm) the final (meta-) gradient may be drawn in the direction of the larger-scale task gradient.

To compensate for this possible bias, example methods can provide task weights w_{T}_{ᵢ} with a goal of balancing the influence of each task on the meta-gradient. For instance, the gradient in line 22 of the example algorithm in FIG. 4 can be replaced by Σ_{T}_{ᵢ}w_{T}_{ᵢ}∇_{θ} [symbol] ᵢ (π_{θ′}_{ᵢ}). If there is a prior knowledge about the tasks, such as, for instance, the influence of the scale L in the above example, this knowledge can be used directly to define the weight wₜ=1/Lₜ.

In other examples, such as but not limited to instances where prior knowledge is lacking, a gradient normalization method can be used. For instance, assuming access to a simple heuristic, such as but not limited to Farthest Insertion (e.g., as disclosed in Rosenkrantz et al., An analysis of several heuristics for the traveling salesman problem. In Ravi et al. (eds.), Fundamental Problems in Computing: Essays in Honor of Professor Daniel J. Rosenkrantz, pp. 45-69. Springer Netherlands, Dordrecht, 2009), the heuristic can be run over a set of instances for each task, and the average obtained tour length can be used as an approximation of the order of magnitude of the task loss. The inverse of that average can then be used as the task weight.

Meta-Learning of Supervised NCO Heuristics

GCN-based heuristic: An example method for meta-learning of a supervised NCO heuristic will now be described with respect to a Graph Convolutional Network (GCN)-based model, such as disclosed in Joshi et al., An Efficient Graph Convolutional Network Technique for the Travelling Salesman Problem. arXiv:1906.01227 [cs, stat], 2019. This GCN-based model takes as input a TSP instance as a graph and outputs predicted probabilities ŝᵢⱼ for each edge ij being part of the optimal solution. The model is trained using a weighted binary cross-entropy loss between the predictions and the ground-truth solution sᵢⱼ provided by the exact solver Concorde (e.g., disclosed in Applegate et al., The traveling salesman problem: a computational study, Princeton University Press, 2006):

[symbol]

(θ|G)=Σ_{ij∈G}w₀sᵢⱼ log(ŝᵢⱼ)+w₁(1−sᵢⱼ)log(1−ŝᵢⱼ) (4)

where w₀ and w₁ are class weights intended to compensate inherent class imbalance. The class imbalance is inherent, as in a graph of size N, there are exactly N positive (in-solution) edges and N²−N negative ones. The predicted probabilities are used as an input to a beam search procedure. For clarity of explanation of the example learning component, the description will refer to the greedy version, though it will be appreciated that other search procedures are possible.

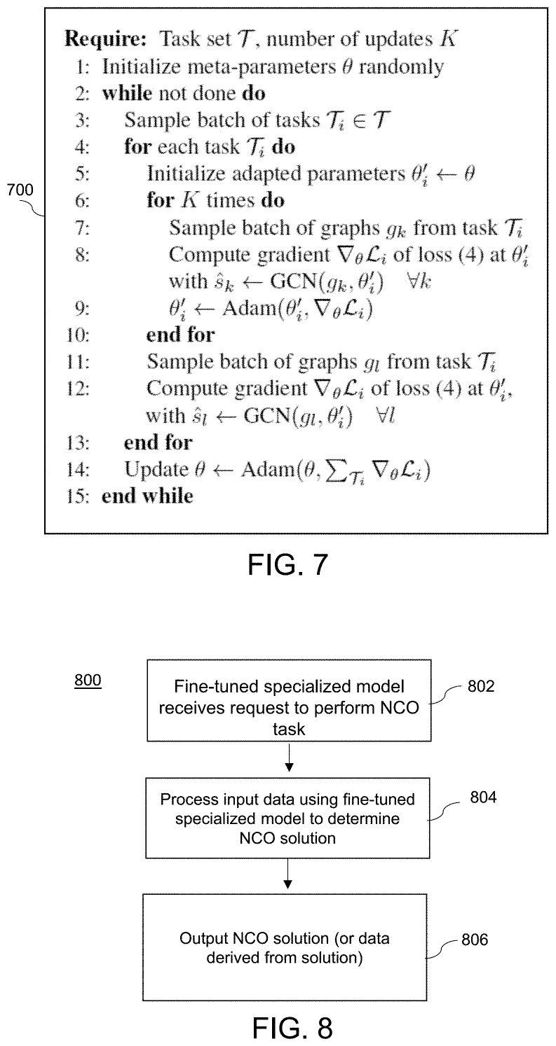

FIG. 7 shows steps in an example meta-training method 700 for the GCN-based model. Since the ground-truth optimal solutions are precomputed, the training tasks in the example method 700 are fixed. Because of the form of the supervised loss in Equation (4), which sums over all the edges of the graph, the task-specific losses [symbol] i may differ in magnitude if they have a large difference in graph size. Factors such as the number of modes and scale are not considered in the example method 700. However, the formula for the class weights w₀, wᵢ in Equation (4) in the GCN-based model, which divides by the number of nodes, partially compensates for this difference. Thus, task weighting is omitted from the example meta-training method, though it can be considered.

In the example meta-learning method 700, given a task set T and a number of updates K, meta-parameters θ are initialized, e.g., randomly (line 1). A batch of tasks Tᵢ∈T are sampled from the task set (line 3). As with the above-described meta-training method for attention-based models, the meta-parameters are then adapted to each of the sampled tasks Tᵢ using a fine-tuning method.

In an example fine-tuning method, for each sampled task Tᵢ (line 4), task-specific adapted parameters θ′ᵢ←θ are initialized with the meta-parameters (line 5). To update the task-specific adapted parameters θ′ᵢ, for each of K updates (line 6), a batch of graphs gₖ are sampled from the task Tᵢ (line 7), and the task-specific adapted parameters θ′ᵢ are updated (line 9) using the sampled batch of graphs to minimize a supervised loss.

For example, over the graphs gₖ a task-specific gradient ∇_{θ} [symbol] ᵢ is computed (line 8) for the supervised loss according to Equation (4), where the predicted probabilities ŝₖ are computed from the GCN model using the task-specific adapted parameters θ′ᵢ. An Adam optimizer can be used to optimize the task-specific adapted parameters, though other optimizers are possible. As with the above meta-learning method 600 for reinforced heuristics, the fine-tuning update in the method 700 may be repeated, e.g., K times.

In addition to the example fine-tuning, a batch of graphs gₗ are sampled from the task Tᵢ (line 11), and over the graphs gₗ a meta-gradient ∇_{θ}Lᵢ is computed (line 12) for the supervised loss according to Equation (4), where the predicted probabilities ŝₗ are computed from the GCN model using the task-specific adapted parameters θ′ᵢ. An Adam optimizer can be used to optimize the task-specific adapted parameters, though other optimizers are possible as will be appreciated by those of ordinary skill in the art.

The meta-parameters θ are then updated (line 14) to minimize the total (e.g., summed) loss across all the sampled tasks Tᵢ in the batch, based on a calculated meta-gradient. An Adam optimizer may be used for this update, though other optimizers are possible.

Once the model is meta-trained, then given a new task, fine-tuning steps similar to lines 6-10 can be performed to provide the specialized model for the new task.

Use of Fine-Tuned Specialized Model

The fine-tuned specialized model (e.g., after specially fine-tuning the meta-learned model for a particular task) can be used to perform NCO tasks using a processor and memory. For instance, FIG. 8 shows an example method 800 executed by a processor for performing an NCO task using the fine-tuned specialized model. The trained specialized model receives a request to perform the NCO task at 802, which may include a data input corresponding to the task (e.g., the graph nodes or edges for the given graph distribution) for which a particular CO problem is formulated. The fine-tuned specialized model is used to process the input data and determine a solution at 804. The CO solution, or data derived from the solution, is output, e.g., displayed, provided for display on a display, stored, printed, transmitted, etc. at 806.

Architecture

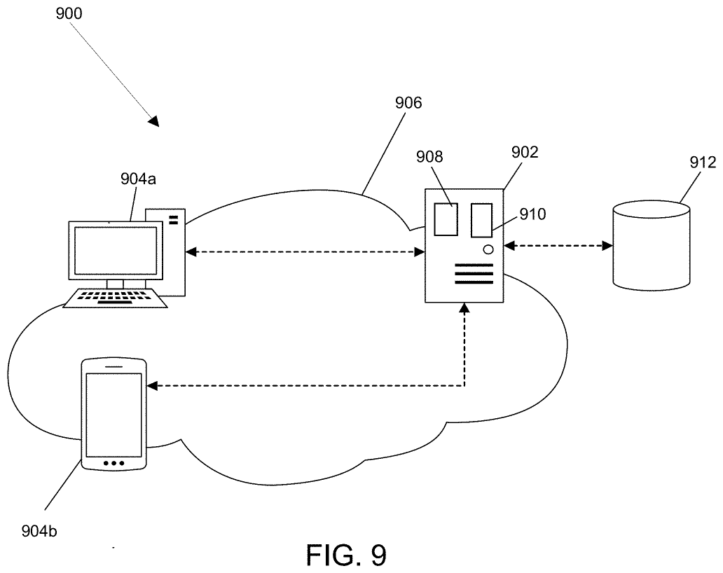

Example systems, methods, and embodiments may be implemented within an architecture 900 such as the architecture illustrated in FIG. 9, which comprises a server 902 and one or more client devices 904a, 904b that communicate over a network 906 which may be wireless and/or wired, such as the Internet, for data exchange. The server 902 and the client devices 904a, 904b can each include a processor, e.g., processor 908 and a memory, e.g., memory 910 (shown by example in server 902), such as but not limited to random-access memory (RAM), read-only memory (ROM), hard disks, solid state disks, or other non-volatile storage media. Memory 910 may also be provided in whole or in part by external storage in communication with the processor 908.

Example methods herein may be performed by the processor 908 or other processor in the server 902 and/or processors in client devices 904a, 904b. It will be appreciated, as explained herein, that the processor 908 can include either a single processor or multiple processors operating in series or in parallel, and that the memory 910 can include one or more memories, including combinations of memory types and/or locations. Server 900 may also include, but are not limited to, dedicated servers, cloud-based servers, or a combination (e.g., shared). Storage, for instance, for storing training data, trained models, etc., can be provided by local storage, external storage such as connected remote storage 912 (shown in connection with the server 902, but can likewise be connected to client devices), or any combination.

Client devices 904a, 904b may be any processor-based device, terminal, etc., and/or may be embodied in a client application executable by a processor-based device, etc. Client devices may be disposed within the server 902 and/or external to the server (local or remote, or any combination) and in communication with the server. Example client devices 904 include, but are not limited to, autonomous computers 904a, mobile communication devices (e.g., smartphones, tablet computers, etc.) 904b, wearable devices, computer vision devices, cameras, virtual reality, augmented reality, or mixed reality devices (not shown), or others. Client devices 904 may be configured for sending data to and/or receiving data from the server 902, and may include, but need not include, one or more output devices, such as but not limited to displays, printers, etc. for displaying, providing for display on a display, or printing results of certain methods that are provided for display by the server. Client devices may include combinations of client devices.

In an example NCO method the server 902 or client devices 904 may receive a query from any suitable source, e.g., by local or remote input from a suitable interface, or from another of the server or client devices connected locally or over the network 906. Trained specialized models for solving NCO tasks, meta-trained models, or NCO models to be meta-trained or trained for specialized tasks (graph distributions) can be likewise stored in the server (e.g., memory 910), client devices 904, external storage 912, or combination. In some example embodiments provided herein, training and/or inference may be performed offline or online (e.g., at run time), in any combination. Results can be output (e.g., displayed, transmitted, provided for display, printed, etc.) and/or stored for retrieving and providing on request.

Generally, embodiments can be implemented as computer program products with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor.

Embodiments described herein may be implemented in hardware or in software. The implementation can be performed using a non-transitory storage medium such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

### EXPERIMENTS

Experiments were conducted to evaluate performance of example meta-learning methods. The experiments included an evaluation of the generalization capability of meta-learned NCO models to unseen graph distributions. Though a particular result is not required in all example embodiments, example methods can fine-tune meta-learned models on a few instances of a new distribution to yield the same or comparable performance as an original model, trained from scratch for that specific distribution. Further, though not required, example methods were found in some instances to improve the original model's performance, in terms of optimality gaps, on fixed graph distributions.

To measure and compare the performance of different TSP algorithms on a given task, a set of test graphs from that task can be sampled, and the solution of the TSP on each sample by each algorithm can be computed. Using the average tour length of these solutions per algorithm provides a measure of performance, but given the nature of the tasks, the solutions' lengths may be quite variable, and that measure would thus be biased by longer lengths. Instead, a reference ratio per algorithm was measured, which was computed as the average, over the test graphs, of the ratio of the solution length of the given algorithm to a reference solution's length. When possible, the reference was the optimal solution provided by the exact solver Concorde, as disclosed in Applegate et al., 2006, in which case the ratio is referred to as the optimality ratio. More particularly, an optimality gap was used, which is the former decremented by 1, and characterizes how much worse (or better if the reference is sub-optimal and the gap is negative) the considered algorithm solutions fared against the reference.

The performance deterioration of generalization of the attention-based model (AM) disclosed in Kool et al., 2018, was measured using the methodology described above. The AM was trained on a given task and tested on the same task, then on one or more other tasks, and then the performance (the optimality gap) was compared. Tasks of the form T_{N,M,L} were used, and in each experiment, only one of the parameters N, M, L was varied between training and test.

Table 1 summarizes the results. Unsurprisingly, the best performances, marked in bold for each test task (along each column), were obtained when the training task was identical to the test one (diagonal of each table). Varying the number of nodes degraded the performance (Table 1a). Further, and surprisingly, varying the number of modes only also had a negative impact (Table 1b).

TABLE 1

| $N \frac{test \to }{train ↓}$ | 20 | 50 | 100 |
|---|---|---|---|
| 20 | 0.08 | 1.78 | 22.61 |
| 50 | 0.35 | 0.52 | 2.95 |
| 100 | 3.78 | 2.33 | 2.26 |
| (a) Size N (M = 0, L = 1) | | | |
| $M \frac{test \to }{train ↓}$ | 0 | 3 | 6 |
| 0 | 1.47 | 32.17 | 2.74 |
| 3 | 26.38 | 1.86 | 7.32 |
| 6 | 6.91 | 6.01 | 2.00 |
| (b) Modes M (N = 40, L = 1) | | | |
| $L \frac{test \to }{train ↓}$ | 1 | 5 | 10 |
| 1 | 1.48 | 282.55 | 292.39 |
| 5 | 32.84 | 1.44 | 13.83 |
| 10 | 98.62 | 7.12 | 1.53 |

(c) Scale L (N = 40, M = 0)

Another surprising and counter-intuitive result involved the impact of scale variations (Table 1c). It can be observed that changing the scale of a TSP instance leaves the structure of the problem rigorously unchanged. With a handcrafted heuristic, one would expect such a change to have no impact at all. However, the results showed that with a learned heuristic, the impact was significant, illustrating problems with such learning techniques.

Also measured was the impact of scale change on the supervised NCO model (GCN model) disclosed in Joshi et al., An Efficient Graph Convolutional Network Technique for the Travelling Salesman Problem. arXiv:1906.01227 [cs, stat], 2019. Substantially similar results were obtained despite the significantly different training approach. Regarding generalization on the number of modes, for a model trained on graphs of uniform node distribution, the average optimality gap went from less than 1% on M=0 to more than 25% on M=1, 41% on M=2, and 25% on M=3. Similarly, a model trained on scale 1 went from less than 1% on L=1 to more than 33% on L=5 and 42% on L=10, while the same model trained on the specific test distribution performed very well.

To assess example methods, experiments first analyzed an NCO model's generalization capacity along three different instance parameters: graph size, spatial distribution of the nodes, and scaling of the graph features (e.g., coordinates of the nodes), highlighting a dramatic drop in performance on out-of-distribution instances. Example experiments further evaluate the efficiency of meta-trained models with different pairs of training and test distributions.

Experiments were performed on a pool of machines running CPUs with 16 cores, 256 GB RAM under CentOS Linux 7, having 4 GPUs with 32 GB GPU memory. 1 GPU was used for the experiments on the attention model, and 2 GPUs were used for experiments on the GCN-based models.

Synthetic TSP instances were generated according to various graph distributions of the form T_{N,M,L} following the process described above. For the attention-based models, training samples were generated on demand. For the GCN-based supervised models, for each task (as in the original work) a training set of 1M instances and validation and test sets of 10K instances were generated, and Concorde was used to obtain the associated ground-truth solutions.

To fine-tune the example meta-trained models on a new task, a set of either 1K or 3K (short (3-10 min) fine-tuning) or 256K (1 hr. fine-tuning only for meta-trained AM) of independently randomly sampled graphs from the task were generated. For testing, 5K graphs used to randomly sample all the models were independently randomly sampled. All the sets (training, fine-tuning, test) were sampled independently from smooth distributions in a continuous space, so they were (almost surely) disjoint, even though the fine-tuning and test sets came from the same distribution.

Three meta-training procedures were performed on the attention-based model using training provided by the method 600, on different distribution sub-families that are variants of T_{N=40,M=0,L=10} along each of the dimensions, resp. the size N∈{10,20,30,50}, number of modes M∈{1,2,5}, and scale L∈{1,2,4}, while the other dimensions were kept unchanged. Each meta-training procedure involved K=50 fine-tuning steps in its inner loop (line 7 in FIG. 600). The remaining hyper-parameters were generally the same as the original model. The obtained models are referred to herein as meta-AM, and the appropriate ones were used depending on the test task, which was chosen to be always distinct from any of the training tasks.

To improve performance on a variety of graph distributions, an approach that has been previously disclosed, e.g., in Joshi et al., Learning TSP Requires Rethinking Generalization, arXiv:2006.07054 [cs, stat], June 2020, and Lisicki et al., Evaluating Curriculum Learning Strategies in Neural Combinatorial Optimization, arXiv:2011.06188 [cs], November 2020, is to train the AM model on graphs coming from a variety of distributions and fine-tune the model on the test distribution. For each of the three sub-families of tasks above, the experiments trained the attention model with samples coming equiprobably from the tasks in that sub-family. These obtained models are referred to in experiments as multi-AM, and again the appropriate one corresponding to the test task was used. The original attention model, referred to as AM, was trained on the test tasks directly to have a target performance for the meta-model.

All of the models were trained for 24 hours, and the best model was kept based on the average ratio of its generated tour lengths compared to the tour lengths of the Farthest Insertion heuristic disclosed in Rosenkrantz et al., 2009), on the validation set. This measure was used instead of the standard average tour length because the latter would be heavily biased by tasks with inherently longer tour lengths (e.g., larger number of nodes, or larger scale).

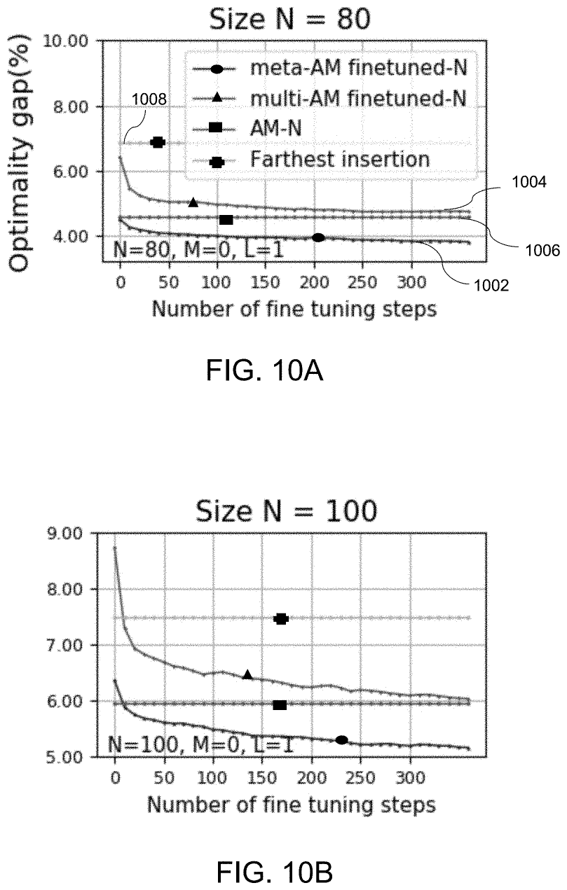

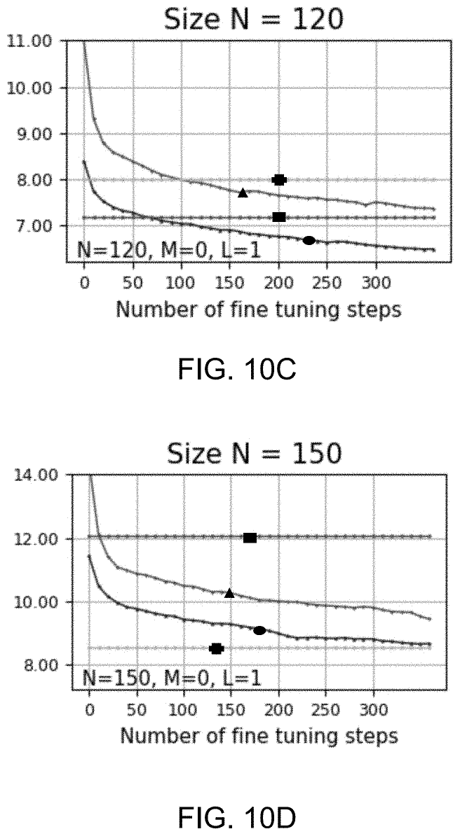

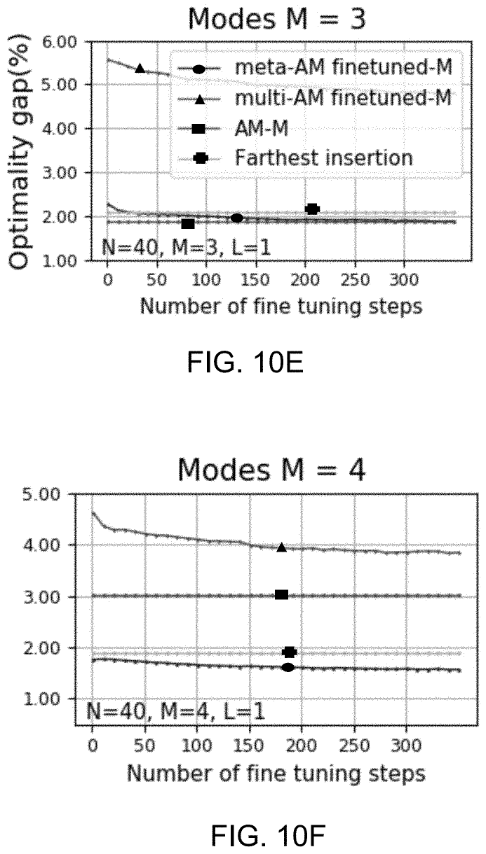

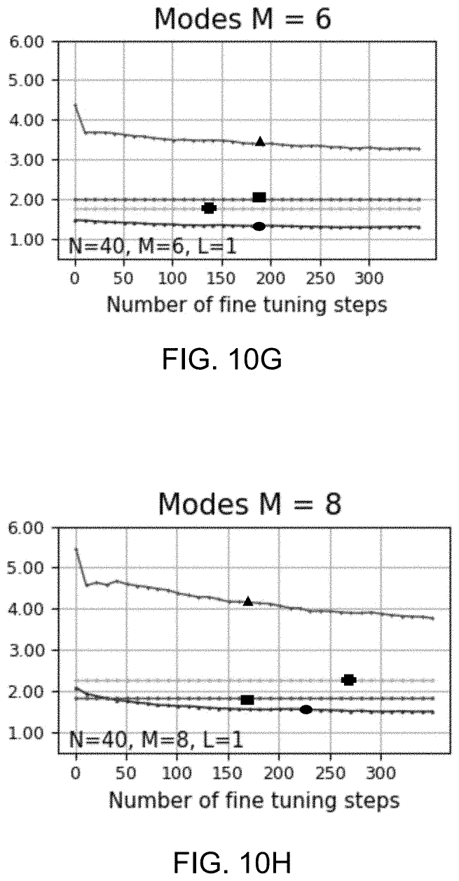

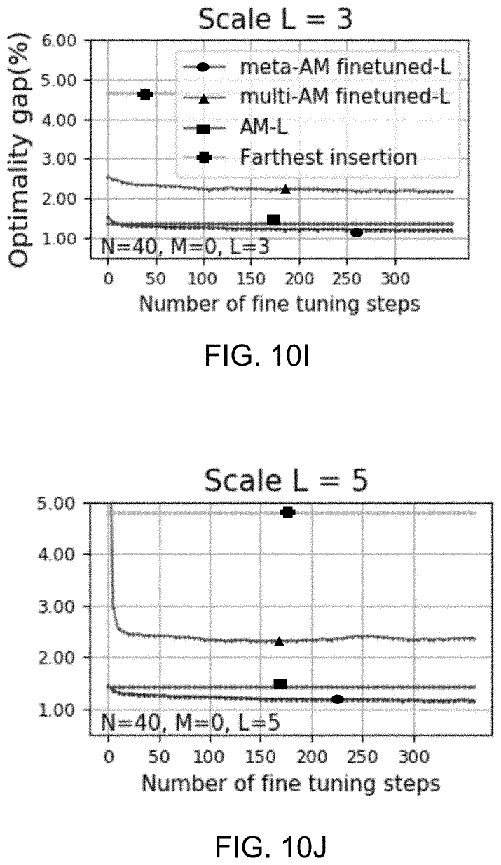

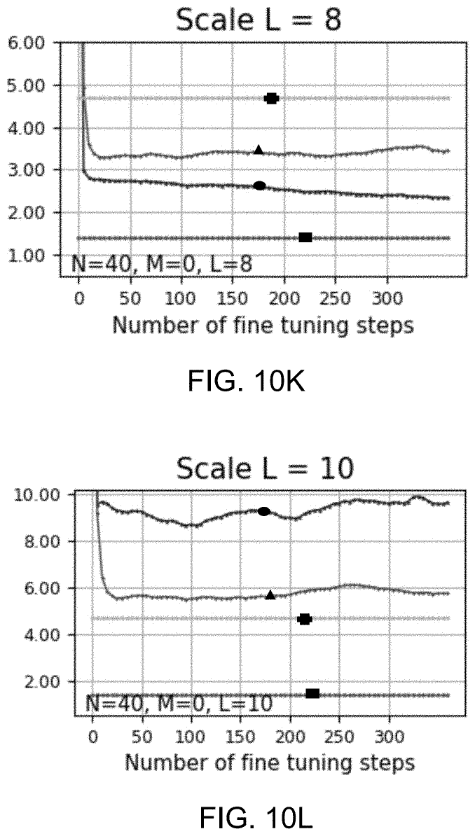

A first set of experiments were conducted to evaluate the ability of the example meta-trained attention model (meta-AM) to adapt to a new, unseen task, i.e., of the learned heuristic, to perform well on graphs of an unseen distribution. FIGS. 10A-10L show the evolution of the performance (optimality gap, vertical axis) of different models on different tasks as well as the example fine-tuning as it progresses at different steps (horizontal access). The distributions are specified in the bottom left corner of each plot. The distributions in each group of four (A-D; E-H, I-L) belong to a subfamily of T_{N,M,L} where two of the parameters N, M, L are fixed and only the third is allowed to vary: N (A-D); M (E-H); and L (I-L).

The performances of four models are provided in each experiment: (1) the AM model meta-trained on a set of distributions of the same subfamily as the distributions in the same group but distinct from them (meta-AM) (line 1002); (2) the AM model trained on the same training distributions as meta-AM but without meta-learning, thus ignoring the origin distribution of the training instances (multi-AM) (line 1004); (3) the AM model trained from scratch on the test distribution, so that the model is in the best testing condition possible (line 1006); and (4) the Farthest Insertion model (line 1008), which, contrary to the others, is not machine learned, and is provided for reference. The first two models (meta-AM and multi-AM, identical across each group) are fine-tuned to the test distribution in each experiment, and the plot shows the evolution of the performance while fine-tuning progresses. The other two models are not fine-tuned and are provided for comparison.

In 11 out of 12 test tasks, meta-AM (line 1002) clearly generalized better than the baseline multi-AM (line 1004). Further, meta-AM generally performed better than the AM model (line 1006) (that is, the model trained from scratch on the test distribution), after at most a few fine-tuning steps (8/12), and did not reach the same performance in only 2/12 tasks, while using a negligible amount of test data compared to the original model.

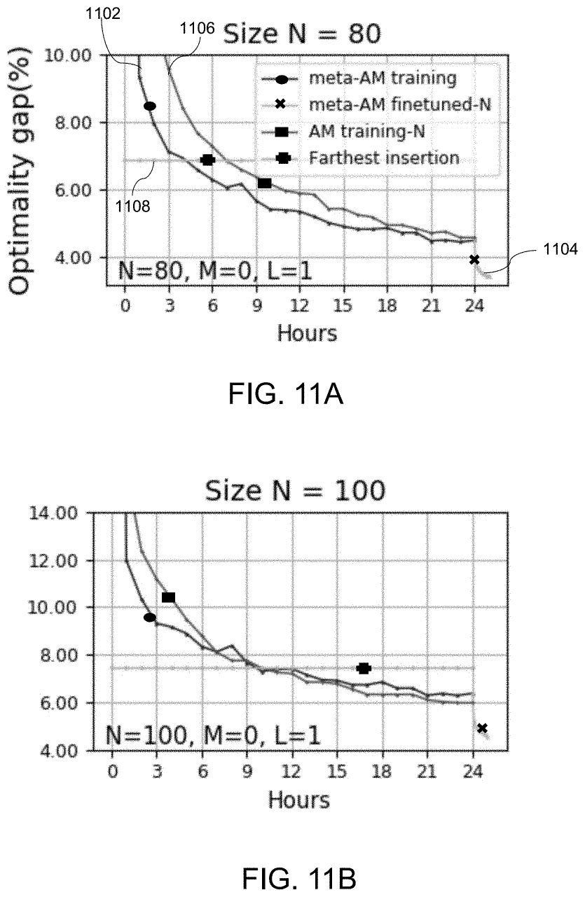

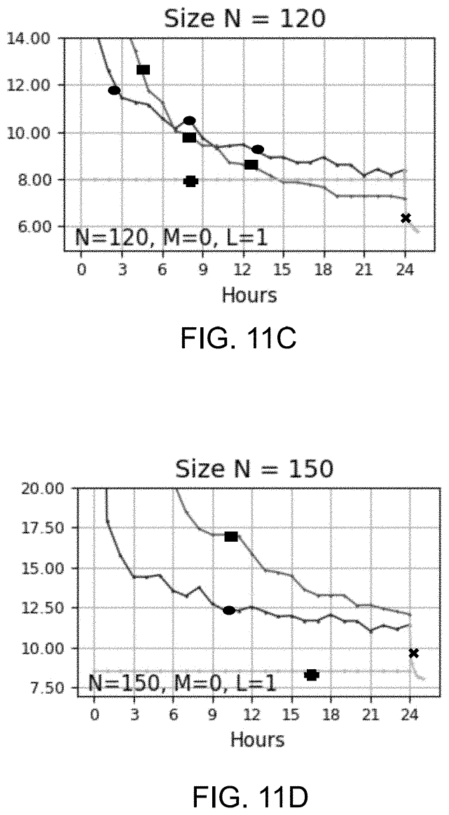

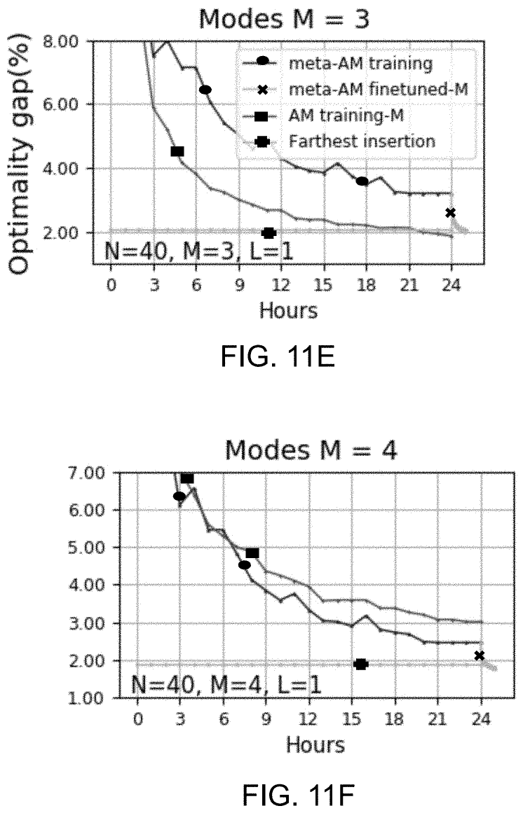

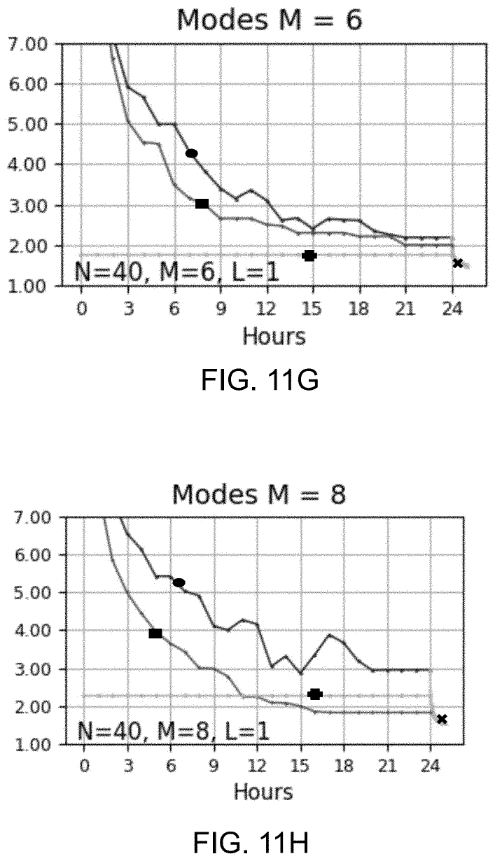

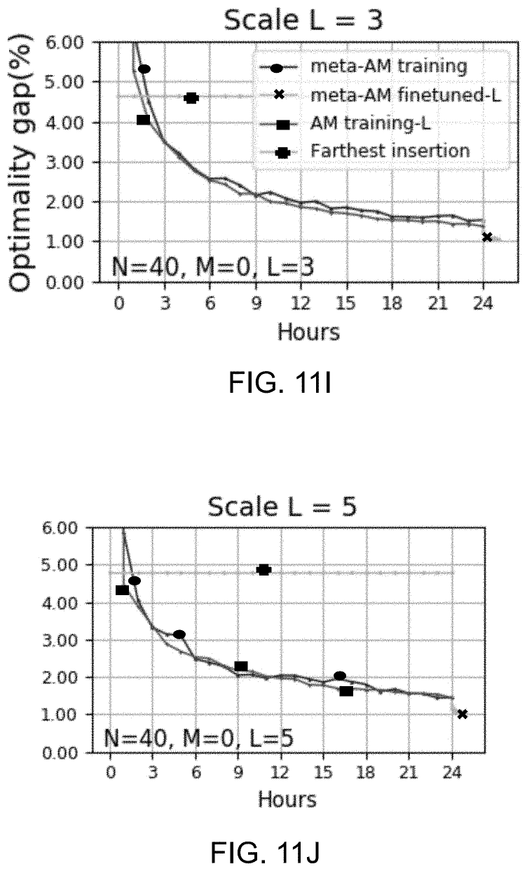

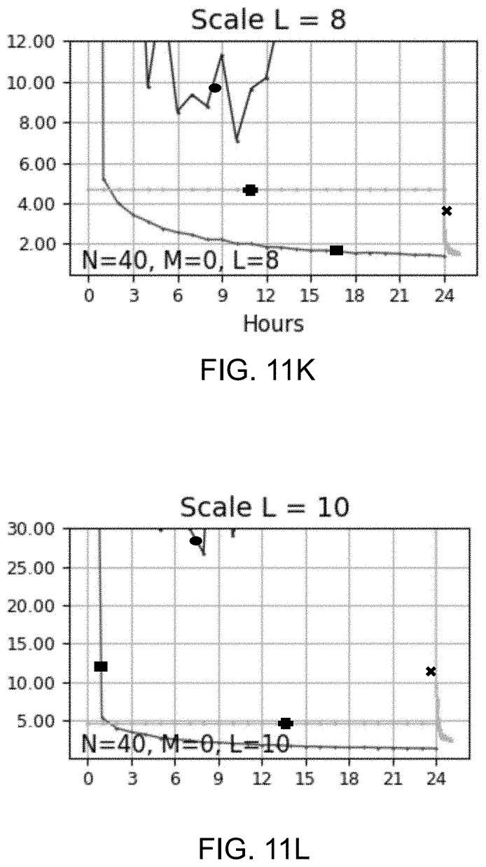

To compare meta-AM and specialized AM, FIGS. 11A-11L show performance on the same train and test tasks of different models during their training, evaluated on the test task. The performance (optimality gap, vertical axis) at different wall clock times of training (horizontal axis) is shown for the models tested on distributions specified in the bottom left corner of each plot (the distributions are the same as shown in FIGS. 11A-11L). Performance is shown for three models: (1) the AM model meta-trained on a set of distributions of the same subfamily as the distributions in the same group but distinct from them (meta-AM, indicating meta-AM training 1102; (2) the AM model trained from scratch on the same distribution as in test (AM training-N 1106); and (3) the Farthest Insertion model 1108, where the parameters N, M, L are varied.

It was observed that although the example meta-model (model (1)) was not optimized to perform well (without fine-tuning) on the unseen tasks, but instead was meta-trained on a variety of distributions, its performance generally consistently improved during the training on 8 of the 12 tests. Model (1) sometimes outperformed and sometimes performed short of model (2), which was directly trained on the test distribution. However, after a last, short fine-tuning (e.g., 1 hr. vs. 24 hrs. training), plotted at the end of the plot for model (1) (line 1104), model (1) eventually caught up with model (2) and often outperformed it in 9 of the 12 tasks. In the other tasks, the performance was equivalent to the model trained from scratch for 21 hours (M=3), 22 hours (L=8), and 10 hours (L=10).

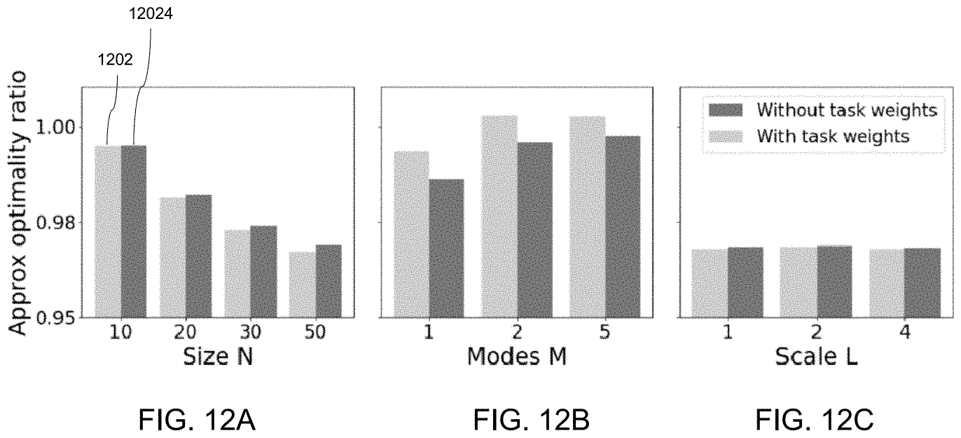

To evaluate the impact of the example task weights, the performance, measured by approximate optimality ratio, of the meta-AM (using the algorithm according to the method 600) was considered with and without the task weights on both training and test tasks. FIGS. 12A-120 show training performance of meta-AM with (left portion 1202 of each combined bar) and without (right portion 1204 of each combined bar) for a set of tasks with varying graph size N (FIG. 12A), number of modes M (FIG. 12B), and scale L (FIG. 12C). Validation performance was provided of the best model, fine-tuned to each task, as the average ratio between the tour length of the computed solutions and those of the Farthest Insertion heuristic (available at training).

It was observed that the ratio was smaller (better) when using task weights int the case of distributions with varying size and scale. For different numbers of modes, though, it was better to not use the task weights. This may be due to the variance of the ratio to the Farthest Insertion across the tasks.

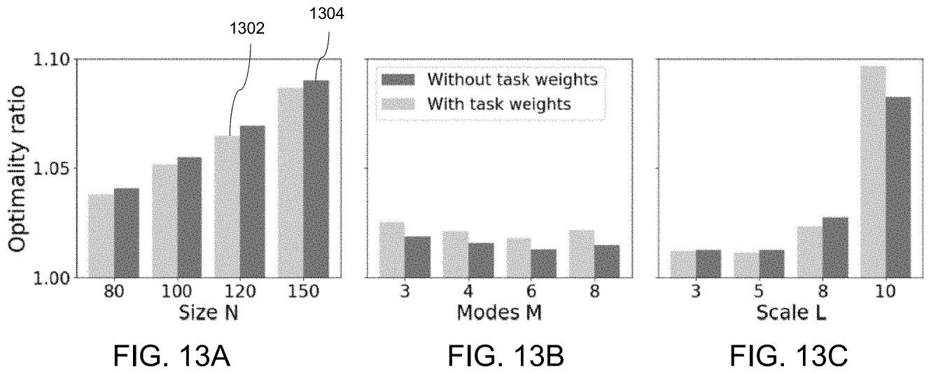

FIGS. 13A-130 show test performance, measured by the true optimality ratio, of the example meta-AM model with (left portion 1302 of each combined bar) or without (right portion 1304 of each combined bar) on the set of tasks with varying graph size N (FIG. 13A), number of modes M (FIG. 13B), and scale L (FIG. 13C). The impact of the task weights on the test performance, measured by the true optimality ratio, is roughly similar to the train performance, although for scale 10 the model without weights performs better. The training results demonstrate benefits of using task weights for size and scale variation.

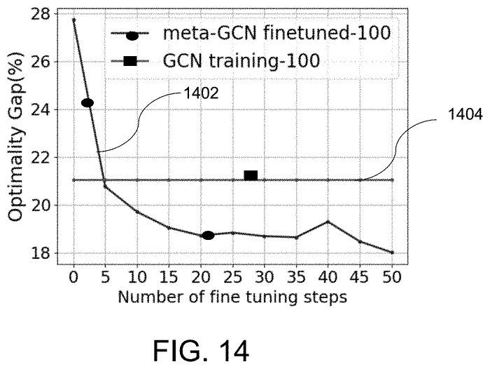

To evaluate performance of meta-training for an example supervised NCO heuristic (GCN model), the GCN model was trained according to the algorithm provided by the example method 700 on tasks T_{N=∈{10,20,30,50},M=0,L=10} and tested on T_{N=100,M=0,L=10}. FIG. 14 shows the evolution of the performance with the fine-tuning steps (line 1402) compared to the GCN model trained from scratch (line 1404), for 24 hrs. on the test distribution. It can be observed that similarly to the example meta-AM model, the meta-GCN model reached the target performance in a few fine-tuning steps (1.5 min) and continued to improve afterwards, using only 1K instances, versus 1M when training from scratch.

General

Embodiments of the present invention provide, among other things, a computer-implemented method for training a neural combinatorial optimization (NCO) model for performing a task having a target distribution using a processor and memory, the method comprising: meta-training the NCO model to learn an efficient heuristic on a set of distributions; and fine-tuning the meta-trained NCO model to specialize a learned heuristic for the target distribution. In addition to any of the above features in this paragraph, the meta-training may use a meta-training set of samples, and the fine-tuning of the meta-trained NCO model may use a fine-tuning set of samples that is smaller than the meta-training set of samples. In addition to any of the above features in this paragraph, the meta-set of samples may comprise a set of sampled instances for each of a set of sampled distributions taken sampled from the set of distributions, and the fine-tuning set of samples comprises a set of sampled instances from the target distribution. In addition to any of the above features in this paragraph, the set of distributions may be selected based on prior knowledge. In addition to any of the above features in this paragraph, the NCO model may be a graph-based model, and the target distribution may be a target graph distribution defined by at least one parameter. In addition to any of the above features in this paragraph, the target graph distribution may be defined by a plurality of parameters. In addition to any of the above features in this paragraph, the plurality of parameters may comprise one or more of number of modes, number of nodes, or scale. In addition to any of the above features in this paragraph, the meta-training may use a reinforcement learning method. In addition to any of the above features in this paragraph, the reinforcement learning method may use an attention-based model. In addition to any of the above features in this paragraph, the meta-training may use a supervised learning method. In addition to any of the above features in this paragraph, the supervised learning method may use a Graph Convolutional Network (GCN)-based model. In addition to any of the above features in this paragraph, the meta-trained model may be defined by learned meta-parameters. In addition to any of the above features in this paragraph, the meta-training may comprise: initializing meta-parameters of the NCO model; sampling a batch of tasks from a set of tasks corresponding to different distributions; adapting task-specific parameters to each sampled task using a fine-tuning method; and updating the meta-parameters to minimize a loss across the sampled tasks. In addition to any of the above features in this paragraph, the adapting task-specific parameters may take place over K instances, where K is a fine-tuning parameter. In addition to any of the above features in this paragraph, the adapting task-specific parameters may comprise, for each sampled task: sampling a batch of graphs from the sampled task; for each sampled graph, generating a CO solution using a model policy defined by the task-specific parameters; and updating the task-specific parameters to minimize a loss gradient across the sampled batch of graphs. In addition to any of the above features in this paragraph, the minimized loss may be with respect to a generated CO solution using a model policy defined by baseline parameters. In addition to any of the above features in this paragraph, the meta-training may further comprise updating the baseline parameters to reduce a gradient loss variance. In addition to any of the above features in this paragraph, the minimized loss may be a supervised loss. In addition to any of the above features in this paragraph, the meta-training may further comprise: sampling an additional batch of graphs from the sampled task; and generating a CO solution using a model policy defined by the task-specific parameters. In addition to any of the above features in this paragraph, the fine-tuning the meta-trained NCO model may comprise: initializing a baseline using the learned meta-parameters; and fine-tuning the model parameters of the meta-trained NCO model according to the target distribution. In addition to any of the above features in this paragraph, the fine-tuning may comprise: sampling a batch of graphs from the task having the target distribution; generating a combinatorial optimization (CO) solution for each sample graph using a model policy defined by the meta-parameters; and updating the meta-parameters to minimize a loss gradient across the sampled batch of graphs. In addition to any of the above features in this paragraph, the NCO model is configured to heuristically solve a traveling salesman problem.

According to additional embodiments, a computer-implemented method for providing a solution to a combinatorial optimization (CO) problem comprises: receiving, by a fine-tuned neural combinatorial optimization (NCO) model trained and fine-tuned according to any of the methods in the previous paragraph, a request to perform an NCO task; processing input data using the fine-tuned NCO model to determine a CO solution; and outputting the CO solution. According to additional embodiments, an apparatus is provided for training a neural combinatorial optimization (NCO) model for performing a task having a target distribution using a processor and memory, the apparatus comprising: a non-transitory computer-readable medium having executable instructions stored thereon for causing a processor and a memory to: meta-train the NCO model to learn an efficient heuristic on a prior set of distributions; and fine-tune the meta-trained NCO model to specialize a learned heuristic for the target distribution. According to additional embodiments, an apparatus is provided for training a neural combinatorial optimization (NCO) model for performing a task having a target distribution using a processor and memory, the apparatus comprising: a non-transitory computer-readable medium having executable instructions stored thereon for causing a processor and a memory to perform any of the methods in the previous paragraph.

According to additional embodiments, a computer-implemented method is provided for training a graph-based neural combinatorial optimization (NCO) model using a processor and memory for performing a task, the NCO model having a target graph distribution defined by a plurality of parameters, the method comprising meta-training the NCO model to learn an efficient heuristic on a set of distributions using a first set of sampled instances for a set of sampled tasks from the set of distributions, wherein the meta-training comprises: fine-tuning the NCO model over the set of sampled tasks to learn meta-parameters; and fine-tuning the meta-trained NCO model to specialize a learned heuristic for the target graph distribution using a second set of sampled instances from the target graph distribution, the second set of sampled instances being smaller than the first set of samples. In addition to any of the above features in this paragraph, the fine-tuning the meta-trained NCO model may comprise fine-tuning the model parameters of the meta-trained NCO model according to the target graph distribution using the learned meta-parameters.

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure. All documents cited herein are hereby incorporated by reference in their entirety, without an admission that any of these documents constitute prior art.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more particular functions embodied in computer programs. The flowchart components and other features described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A computer-implemented method for training a neural combinatorial optimization (NCO) model for performing a task having a target distribution using a processor and memory, the method comprising:
meta-training the NCO model using the processor to learn an efficient heuristic on a set of distributions; and
fine-tuning the meta-trained NCO model using the processor to specialize a learned heuristic for the target distribution.

2. The computer-implemented method of claim 1, wherein said meta-training uses a meta-training set of samples, and wherein said fine-tuning the meta-trained NCO model uses a fine-tuning set of samples that is smaller than the meta-training set of samples.

3. The computer-implemented method of claim 1, wherein said meta-training set of samples comprises a set of sampled instances for each of a set of sampled distributions taken from the set of distributions and said fine-tuning set of samples comprises a set of sampled instances from the target distribution.

4. The computer-implemented method of claim 3, wherein the set of distributions is selected based on prior knowledge.

5. The computer-implemented method of claim 1, wherein the NCO model is a graph-based model, and wherein the target distribution is a target graph distribution defined by at least one parameter.

6. The computer-implemented method of claim 5, wherein the target graph distribution is defined by a plurality of parameters.

7. The computer-implemented method of claim 6, wherein the plurality of parameters comprises one or more of number of modes, number of nodes, or scale.

8. The computer-implemented method of claim 5, wherein said meta-training uses a reinforcement learning method.

9. The computer-implemented method of claim 8, wherein said reinforcement learning method uses an attention-based model.

10. The computer-implemented method of claim 5, wherein said meta-training uses a supervised learning method.

11. The computer-implemented method of claim 10, wherein said supervised learning method uses a Graph Convolutional Network (GCN)-based model.

12. The computer-implemented method of claim 5, wherein said meta-trained model is defined by learned meta-parameters.

13. The computer-implemented method of claim 12, wherein said meta-training comprises:
initializing meta-parameters of the NCO model;
sampling a batch of tasks from a set of tasks corresponding to different distributions;
adapting task-specific parameters to each sampled task using a fine-tuning method; and
updating the meta-parameters to minimize a loss across the sampled tasks.

14. The computer-implemented method of claim 13, wherein said adapting task-specific parameters takes place over K instances, where K is a fine-tuning parameter.

15. The computer-implemented method of claim 13, wherein said adapting task-specific parameters comprises, for each sampled task:
sampling a batch of graphs from the sampled task;
for each sampled graph, generating a CO solution using a model policy defined by the task-specific parameters; and
updating the task-specific parameters to minimize a loss gradient across the sampled batch of graphs.

16. The computer-implemented method of claim 15, wherein the minimized loss is with respect to a generated CO solution using a model policy defined by baseline parameters.

17. The computer-implemented method of claim 16, wherein said meta-training further comprises:
updating the baseline parameters to reduce a gradient loss variance.

18. The computer-implemented method of claim 15, wherein the minimized loss is a supervised loss.

19. The computer-implemented method of claim 15, wherein said meta-training further comprises:
sampling an additional batch of graphs from the sampled task; and
generating a CO solution using a model policy defined by the task-specific parameters.

20. The computer-implemented method of claim 12, wherein said fine-tuning the meta-trained NCO model comprises:
initializing a baseline using the learned meta-parameters; and
fine-tuning the model parameters of the meta-trained NCO model according to the target distribution.

21. The computer-implemented method of claim 20, wherein said fine-tuning comprises:
sampling a batch of graphs from the task having the target distribution;
generating a combinatorial optimization (CO) solution for each sample graph using a model policy defined by the meta-parameters; and
updating the meta-parameters to minimize a loss gradient across the sampled batch of graphs.

22. The computer-implemented method of claim 1, wherein the NCO model is configured to heuristically solve a traveling salesman problem.

23. A computer-implemented method for providing a solution to a combinatorial optimization (CO) problem, the method comprising:
receiving, by a processor, a request to perform a CO task, the request including input data;
processing the input data using the processor and a fine-tuned neural combinatorial optimization (NCO) model stored in memory to determine a CO solution; and
outputting the CO solution;
wherein the fine-tuned NCO model is trained and fine-tuned by:
meta-training an NCO model to learn an efficient heuristic on a set of distributions; and
fine-tuning the NCO model to specialize a learned heuristic for the target distribution and generate the fine-tuned NCO model.

24. An apparatus for training a neural combinatorial optimization (NCO) model for performing a task having a target distribution using a processor and memory, the apparatus comprising:
a non-transitory computer-readable medium having executable instructions stored thereon for causing a processor and a memory to:
meta-train the NCO model to learn an efficient heuristic on a prior set of distributions; and
fine-tune the meta-trained NCO model to specialize a learned heuristic for the target distribution.

25. A computer-implemented method for training a graph-based neural combinatorial optimization (NCO) model for performing a task, the NCO model having a target graph distribution defined by a plurality of parameters, the method comprising:
meta-training the NCO model using a processor to learn an efficient heuristic on a set of distributions using a first set of sampled instances for a set of sampled tasks from the set of distributions, said meta-training comprising fine-tuning the NCO model over the set of sampled tasks to learn meta-parameters; and
fine-tuning the meta-trained NCO model using the processor to specialize a learned heuristic for the target graph distribution using a second set of sampled instances from the target graph distribution, the second set of sampled instances being smaller than the first set of sampled instances.

26. The computer-implemented method of claim 25, wherein said fine-tuning the meta-trained NCO model comprises:
fine-tuning the model parameters of the meta-trained NCO model according to the target graph distribution using the learned meta-parameters.
